(19) United States
(12) Patent Application Publication
(10) Pub. No.: US 2010/0028777 A1
(43) Pub. Date: Feb. 4, 2010

(54) Nonaqueous Electrolyte Secondary Batteries

(75) Inventors: Atsushi UEDA, Hitachi (JP); Tatsuya TOYAMA, Hitachi (JP); Kazushige KOHNO, Hitachi (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Tokyo (JP)

(21) Appl. No.: 12/534,441

(22) Filed: Aug. 3, 2009

(30) Foreign Application Priority Data
Aug. 4, 2008 (JP) 2008-200327

(51) Int. Cl. H01M 4/36

(52) U.S. Cl. 429/221; 429/224; 429/223

(57) ABSTRACT

The present invention is intended to improve load characteristics at the time of charging or discharging by assuring a lithium ion transport pathway in the crystal structure of olivine lithium-containing manganese phosphate. There is used a positive electrode active material which is a composite material comprising a material having an olivine structure and represented by Li_{1-y}[Mn₁₋ₓMₓ]PzO₄ (0<x≦0.3, −0.05≦y<1, 0.99≦z≦1.03, and M includes at least one of Li, Mg, Ti, Co, Ni, Zr, Nb, Mo or W) and a carbon material, and which shows an average half width of 0.17 or more, and an intensity ratio between a diffraction line near 20° and a diffraction line near 35° of not less than 0.7 and not more than 1.0, in powder X-ray diffractometry.

### FIELD OF THE INVENTION

The present invention relates to nonaqueous electrolyte secondary batteries having improved load characteristics at the time of charging and discharging.

### BACKGROUND OF THE INVENTION

Lithium cobalt oxide has been a leading positive electrode active material for nonaqueous electrolyte batteries. However, since cobalt as a starting material for lithium cobalt oxide occurs in only a small quantity and hence is expensive, the employment of lithium cobalt oxide raises the cost of production of the batteries. Moreover, batteries using lithium cobalt oxide are poor in safety in the case of a raise in the battery temperature.

Therefore, consideration is given to the utilization of lithium manganese oxide, lithium nickel oxide and the like as a positive electrode active material in place of lithium cobalt oxide. However, lithium manganese oxide is disadvantageous, for example, in that it cannot give a sufficient discharge capacity and that manganese is melted when the battery temperature is raised. On the other hand, lithium nickel oxide is disadvantageous, for example, in that the discharge voltage is dropped.

Accordingly, as positive electrode active materials substitutable for lithium cobalt oxide, olivine lithium metal phosphates such as LiCoPO₄ and LiFePO₄ have recently been noted which have a low heating value, have a high safety at a high temperature and hardly undergo metal melting. Various research results have been reported in patent documents 1 to 3. The olivine lithium metal phosphates are lithium mixed compounds represented by the general formula LiMPO₄ (M represents at least one element selected from Co, Ni, Mn and Fe) and are different in operating voltage, depending on the kind of the metal element M as core. Therefore, they are advantageous in that any battery voltage can be chosen by the selection of M and that a relatively high theoretical capacity of about 140 to 170 mAh/g can be attained, so that the battery voltage per unit mass can be increased. Furthermore, they are advantageous in that iron can be selected as M in the above general formula and that the production costs can be greatly reduced by the use of iron because iron occurs in a large quantity and hence is inexpensive.

However, the employment of the olivine lithium metal phosphates as positive electrode active materials for nonaqueous electrolyte batteries involves unsolved problems. That is, it involves the following problem. The olivine lithium metal phosphates undergo a slow lithium ion intercalation and deintercalation reaction at the time of charging or discharging of the battery, and have a much higher electrical resistance than do lithium cobalt oxide, lithium nickel oxide, lithium manganese oxide and the like. Therefore, batteries using the olivine lithium metal phosphates are inferior in discharge capacity to heretofore known batteries using lithium cobalt oxide. Particularly at the time of high-rate discharging, their battery characteristics are markedly deteriorated because of an increase in resistance overvoltage or activation overvoltage.

The cause of the above problem in the olivine lithium metal phosphates is conjectured as follows: since the P—O bond in the olivine lithium metal phosphates is very strong, the Li—O interaction is relatively weakened which directly participates in the intercalation and deintercalation of lithium. Patent document 4 discloses a means for alleviating such a defect of the olivine lithium metal phosphates. Patent document 5 discloses a technique for supporting powder of an electroconductive material having a higher redox potential than does LiFePO₄, on LiFePO₄ powder and a technique for increasing the reaction area in order to carry out the intercalation and deintercalation of lithium efficiently.

LiFePO₄ fine particles incorporated with carbon by such a technique are used as a positive electrode material for lithium secondary batteries, and lithium secondary batteries using them are on the market.

However, the operating voltage of LiFePO₄ is as low as 3.4 V as compared with lithium cobalt oxide, spinel lithium manganese oxide and the like, resulting in a low energy density. In addition, it is known that regarding iron and iron oxide in a positive electrode or a battery, iron is melted under specific conditions and deposited on a negative electrode to produce an internal short circuit. Therefore, iron is controlled as an impurity element in positive electrode materials such as lithium cobalt oxide. When LiFePO₄ is used as a positive electrode material, the control of iron and iron oxide becomes difficult, so that the probability of occurrence of a short circuit phenomenon is increased. In the worst case, iron cannot be controlled and produces a short circuit which causes ignition. Thus, the reliability and safety of a battery system including a production process are deteriorated.

Therefore, LiMnPO₄ is developed which comprises Mn which has the next highest Clarke number to that of Fe as M in LiMPO₄ (M represents at least one element selected from Co, Ni, Mn and Fe) and has a high operating voltage. However, as disclosed in non-patent documents 1 and 2, the electric conductivity of olivine LiMnPO₄ is still lower than that of LiFePO₄ and its capacity use efficiency is considerably lower than that of LiFePO₄. Thus, olivine LiMnPO₄ cannot be substituted for LiFePO₄. In addition, by presumption, the following is also considered as the cause of the low capacity use efficiency: the lattice size is greatly changed at the time of lithium deintercalation, so that the mismatch of the lattice occurs.

[Patent Document 1] JP-A-9-134724

[Patent Document 2] JP-A-9-134725

[Patent Document 3] JP-A-2001-85010

[Patent Document 4] JP-A-2001-110414

[Patent Document 5] Japanese Patent No. 3441107 (U.S. Pat. No. 5,538,814)

[Non-Patent Document 1] M. Yonemura, et al., Journal of the Electrochemical Society, 151, A1352 (2004)

[Non-Patent Document 2] C. Delacourt, et al., Journal of the Electrochemical Society, 152, A913 (2005)

### BRIEF SUMMARY OF THE INVENTION

Accordingly, the present invention is intended to improve the load characteristics of olivine LiMnPO₄ which has the characteristics of olivine lithium metal phosphates, i.e., a high thermal stability and difficult metal melting at a high temperature, and has an operating voltage of about 4 V. In addition, the present invention is intended to provide a safe battery system by avoiding the employment of iron as an element constituting a positive electrode active material, in order to control iron impurity in the positive electrode active material.

The present invention provides a nonaqueous electrolyte secondary battery comprising: a positive electrode being capable of undergoing lithium ion intercalation and deintercalation; and a negative electrode being capable of undergoing lithium ion intercalation and deintercalation, which are formed with an electrolyte inserted between them,

wherein the positive electrode comprises a positive electrode active material,

the positive electrode active material is a composite material comprising a material represented by Li_{1-y}Mn_{1-α}PzO₄ (−0.05<α<0.05, −0.05≦y<1, 0.99≦z≦1.03) and a carbon material, and

the ratio of the intensity of a (011) diffraction line near 20° to the intensity of a (131) diffraction line near 35° in powder X-ray diffractometry of the composite material is not less than 0.7 and not more than 0.8.

The nonaqueous electrolyte secondary battery is characterized also in that an average half width in the powder X-ray diffractometry of the composite material is not less than 0.16 and not more than 0.18.

In addition, a carbon content of the composite material is preferably not less than 3 wt % and not more than 7 wt %, and the carbon material is preferably a polysaccharide containing alpha-glucose and is more preferably dextrin.

Further, the present invention provides a nonaqueous electrolyte secondary battery comprising: a positive electrode being capable of undergoing lithium ion intercalation and deintercalation; and a negative electrode being capable of undergoing lithium ion intercalation and deintercalation, which are formed with an electrolyte inserted between them,

wherein the positive electrode comprise: a positive electrode combination agent comprising a positive electrode active material and a conductive aid; and a positive electrode current collector,

the positive electrode active material is a composite material comprising a material represented by Li_{1-y}Mn_{1-α}PzO₄ (−0.05<α<0.05, −0.05≦y<1, 0.99≦z≦1.03) and a carbon material,

an average half width in powder X-ray diffractometry of the composite material is not less than 0.16 and not more than 0.18,

the ratio of the intensity of a (011) diffraction line near 20° to the intensity of a (131) diffraction line near 35° in the powder X-ray diffractometry of the composite material is not less than 0.7 and not more than 0.8,

the conductive aid is a carbon material, and

a carbon content of the positive electrode combination agent is not less than 5 wt % and not more than 10 wt %.

Moreover the present invention provides a nonaqueous electrolyte secondary battery comprising: a positive electrode being capable of undergoing lithium ion intercalation and deintercalation; and a negative electrode being capable of undergoing lithium ion intercalation and deintercalation, which are formed with an electrolyte inserted between them,

wherein the positive electrode comprises a positive electrode active material,

the positive electrode active material is a composite material comprising a material represented by Li_{1-y}[Mn₁₋ₓMₓ]PzO₄ (0<x≦0.3, −0.05≦y<1, 0.99≦z≦1.03, and M includes at least one of Li, Mg, Ti, Co, Ni, Zr, Nb, Mo or W) and a carbon material,

an average half width in powder X-ray diffractometry of the composite material is not less than 0.16 and not more than 0.18, and

the ratio of the intensity of a (011) diffraction line near 20° to the intensity of a (131) diffraction line near 35° in the powder X-ray diffractometry of the composite material is not less than 0.7 and not more than 1.0.

Furthermore, the present invention provides the above nonaqueous electrolyte secondary battery, wherein the positive electrode active material is a composite material comprising a material represented by Li_{1-y}[Mn₁₋ₓ₁₋ₓ₂M1ₓ₁M2ₓ₂]PzO₄ (0<x1+x2≦0.3, 0<x1≦0.25, 0<x2≦0.05, −0.05≦y<1, 0.99≦z≦1.03; M1 includes at least one of Co or Ni, and M2 includes at least one of Mg, Ti, Zr, Nb, Mo or W) and a carbon material.

Further, the positive electrode active material is characterized in that a carbon content thereof is not less than 3 wt % and not more than 7 wt % and a Fe content thereof is 100 ppm or less.

Other objects, features and advantages of the invention will become apparent from the following description of the embodiments of the invention taken in conjunction with the accompanying drawings.

### BRIEF DESCTIPTION OF THE DRAWINGS

FIG. 1 shows the result of LiMnPO₄ Rietveld analysis and the position parameters of each element.

FIG. 2 is an image diagram of the occupation of a lithium transport pathway by Mn.

FIG. 3 shows the change (calculated values) of the intensity ratio between diffraction lines, I (011)/I (131) in the case of a Li₁₋ₓMnₓ[Mn₁₋ₓLiₓ]PO₄ model.

FIG. 4 shows the relationship between I (011)/I (131) and capacity use efficiency.

### DETAILED DESCRIPTION OF THE INVENTION

Since divine LiMnPO₄ has a low electric conductivity, its capacity use efficiency is improved by reducing the particle size and increasing the reaction area. In addition, the reason for the low load characteristics of olivine LiMnPO₄ is considered as follows: the change of the lattice size at the time of lithium deintercalation is remarkable, so that the mismatch of the lattice is caused. In the present invention, besides the above reason, a one-dimensional lithium ion transport pathway characteristic of olivine structure is noted. The assurance of a lithium ion transport pathway in a crystal structure for improving the energy efficiency at the time of charging or discharging is an idea adopted also in the days of the development of lithium nickel oxide known as a positive electrode material. Lithium nickel oxide is a laminar compound having a two-dimensional lithium ion transport pathway. When site exchange occurs between lithium and nickel, the lithium ion transport pathway is blocked, resulting in a decrease in the transport efficiency of lithium, and hence no sufficient discharge capacity can be attained. Therefore, the following idea was adopted: the capacity use efficiency of olivine LiMnPO₄ can be improved by designing a production process and suppressing the site exchange by replacement with foreign metals. A detailed explanation is given below.

The present inventors investigated the characteristics of olivine structure earnestly in detail and examined a means for reducing the occupancy of a metal element (Mn) as obstacle in the lithium transport pathway of LiMnPO₄ having a space group Pnma. Consequently, the present inventors found the following two methods. (1) The occupancy of Mn in the lithium transport pathway can be reduced by replacing Mn with a foreign metal in a proportion of 20 at % or less. (2) It was newly found that the occupancy of Mn in the lithium transport pathway can be reduced by suppressing the grain growth by using dextrin composed of alpha-glucose which is easily carbonized at a lower temperature, as a carbon source incorporated with olivine LiMPO₄ having a low electroconductivity. By uniting the above two techniques, carbon-incorporated Li[Mn₁₋ₓMₓ]PO₄ having a high capacity use efficiency could be invented.

Powder X-ray diffractometry was used as a means for confirming the assurance of the lithium transport pathway in the olivine LiMPO₄ structure having a space group Pnma. The confirmation was carried out on the basis of the following reaction formula:

LiH₂PO₄+MnC₂O₄.2H₂O→LiMnPO₄+2CO₂+½H₂+H₂O (reaction formula 1)

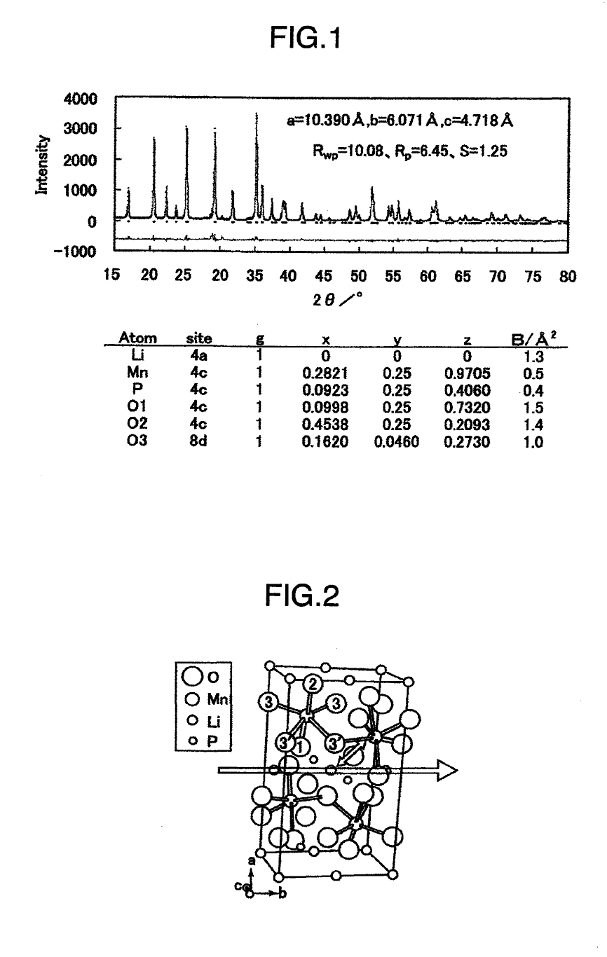

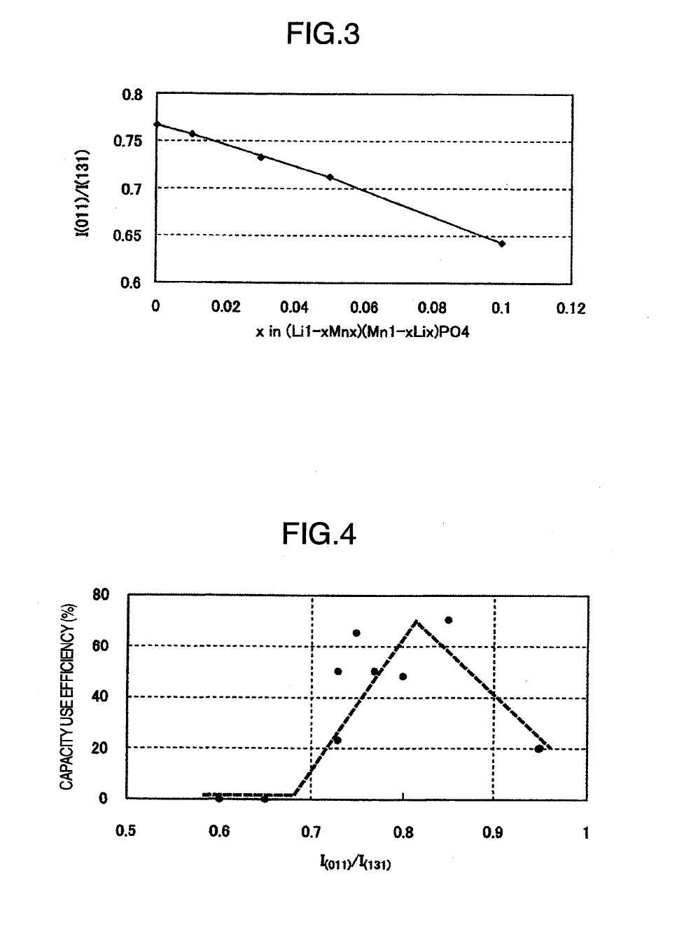

Balls were placed in a pot made of zirconium oxide, and 2.675 g of LiH₂PO₄ (mfd. by Aldrich Chemical Co.) and 4.374 g of MnC₂O₄.2H₂O (mfd. by Pure Material Laboratory Ltd.) were mixed for 30 minutes at a number of revolution of level 3 by the use of a planetary ball mill (Planetary micro mill pulverisette 7; mfd. by Fritsch). The resulting mixed powder was placed in a crucible made of alumina and was first-sintered at 400° C. for 10 hours in an argon stream of 0.3 L/min. After the first-sintered powder was once pulverized in a mortar, it was placed in a crucible made of alumina and was second-sintered at 700° C. for 10 hours in an argon stream of 0.3 L/min. The powder thus obtained was pulverized in a mortar and subjected to size control with a 40-μm mesh sieve to obtain the desired LiMnPO₄ material. Its crystal lattice parameters and position parameters at sites of Li (4a site), Mn (4c site), P (4c site) and O (4c site and 8d site) were obtained by Rietveld analysis method by employing powder X-ray diffractometry. The results obtained are summarized in FIG. 1. In this case, Rietan-2000 (F. Izumi and T Ikeda, Mater. Sci. Forum, 321-324 (2000) 198-203.) was used as a powder X-ray diffraction analysis program. The crystal structure parameters obtained were fixed and a compound in the case of FIG. 2 in which metal elements (M) occupy a lithium transport pathway is assumed to be Li_{1-y}Mnₓ[Mn₁₋ₓLiₓ]PO₄. The degree of manganese occupation in the lithium transport pathway is denoted by an x value, and a powder X-ray diffraction profile in the case of an increase in the x value caused by position exchange between lithium at 4a site and manganese at 4c site was calculated. As a result, it was found that as shown in FIG. 3, the intensity ratio between (011) diffraction line and (131) diffraction line is decreased with an increase in the x value. Therefore, in the present invention, the degree of occupation of the lithium transport pathway by metal elements was evaluated by employing as an indication the intensity ratio between (011) diffraction line and (131) diffraction line obtained by powder X-ray diffractometry. The present inventors considered that the capacity use efficiency can be improved with an increase in the intensity ratio between (011) diffraction line and (131) diffraction line.

When Co and/or Ni are used as elements for the replacement, the resulting compound has the same structure as olivine LiMnPO₄ structure. It was conjectured that since divalent metal ions are stable, the occupation of the lithium transport pathway is suppressed by the stabilization of manganese near the divalent metal ions.

As elements for the replacement, Mg, Ti, Zr, Nb and Mo are easily oxidized to become tetravalent, pentavalent or hexavalent and do not participate in charging reaction. Therefore, it is conjectured that these elements are effective in suppressing the mismatch of lattice size by the relaxation of cooperative Jahn-Teller strain produced by an increase in trivalent manganese caused at the time of charging. While such an effect can be expected also in the case of Fe or Co, Fe and Co are different from the above elements in that they are oxidized to become trivalent in a charging process. In addition, when Co or Ni is used, the resulting compound has the same olivine structure. Therefore, the amount of Co or Ni in which Mn can be replaced therewith is also different from the amount of Mg, Ti, Zr, Nb and Mo.

In such investigation, a lithium-rich composition was also investigated by the same method as above. As a result, it was found that when the compositional formula is assumed to be Li[Mn₁₋ₓLiₓ]PC₄, the intensity ratio between (011) diffraction line and (131) diffraction line tends to be decreased with an increase in the x value as shown in FIG. 3. That is, it was predicted that also when a lithium-rich composition is employed inside the same design guideline, the lithium transport pathway is not blocked and the capacity use efficiency is improved.

Next, the carbon material incorporated with divine LiMPO₄ for improving the electroconductivity is explained. In order to improve the capacity use efficiency of olivine LiMPO₄ having a low electroconductivity, its incorporation with carbon has heretofore been investigated. There is a method in which olivine LiMPO₄ is mechanically mixed with a carbon material having a large specific area, or is mixed with a specific hydrocarbon compound, and the resulting mixture is sintered under an inert atmosphere to effect carbonization, i.e., chemical incorporation with carbon. Accordingly, the present inventors earnestly investigated and consequently found the following: depending on the kind of a carbon source, the particle size observed by an electron microscope and the half width of powder X-ray diffraction line, of course, vary, and the above-mentioned ratio between (011) diffraction line and (131) diffraction line also varies.

When a carbon material having a large specific surface area is mixed with olivine LiMPO₄ before sintering and the resulting mixture is sintered, the incorporation with carbon is impossible and the electric conductivity of the sintered mixture is not different from that attained by mere mixing. However, since LiMPO₄ need to be sintered under an inert atmosphere, the presence of a carbon material having a large specific surface area, such as ketjen black together with LiMPO₄ is effective in removing the excess oxygen. On the other hand, when a hydrocarbon compound such as cellulose or sucrose is mixed with starting powder and the resulting mixture is subjected to carbonization under an inert atmosphere, the formation of carbon electroconductive nets on the surfaces of primary particles and the surfaces and insides of aggregated particles is possible besides the above-mentioned removal of the excess oxygen. Therefore, the term “incorporation with carbon” is used herein.

The present inventors further carried out earnest investigation and consequently confirmed with the aid of an electron microscope that dextrin, a polysaccharide composed of alpha-glucose gives powder having a smaller primary-particle size as compared with cellulose composed of beta-glucose. It was found that by contrast, when cellulose is used, a larger primary-particle size is attained as compared with the addition of a carbon material such as ketjen black. From the above, it is conjectured that the presence of dextrin composed of alpha-glucose and having a spiral structure, among particles suppresses grain growth more effectively, so that the movement of Mn through the grain boundary surfaces is inhibited, resulting in a decrease in Mn occupancy in the lithium transport pathway. As a result, it was found that the intensity ratio between (011) diffraction line and (131) diffraction line is increased by the employment of a sugar containing alpha-glucose, in particular, dextrin. On the other hand, it was conjectured that since cellulose is composed of beta-glucose and hence has a sheet-like structure, it enhances adhesion among particles and hence promotes the grain growth. It was conjectured that as a result of the promotion, strain in crystallites is accumulated and that the degree of occupation of the lithium transport pathway by manganese is increased, resulting in a decrease in the intensity ratio between (011) diffraction line and (131) diffraction line.

As a result of detailed investigation, the present inventors found that depending on the kind of the hydrocarbon used, some materials increase the primary-particle size and other materials suppress the grain growth. Such difference in the grain growth was visually confirmed with the aid of an electron microscope or was confirmed on the basis of the half width of diffraction lines obtained by powder X-ray diffractometry. According to Scherrer's equation, the size of crystallites can be estimated. Therefore, the average of the half widths of five diffraction lines in the exponential forms (011), (120), (031), (211) and (140) was used as a measure of the size of crystallites. That is, it is considered that the degree of grain growth is decreased with an increase in the average half width. For the measurement, RINT2000 manufactured by Rigaku International Corporation was used as a powder X-ray diffraction apparatus, and monochroic Kα1 ray obtained with a graphite monochrometer by using the Kα ray of Cu as a ray source was used. The measuring conditions were as follows: tube voltage 48 kV, tube current 40 mA, scan range 15°≦2θ≦80°, scan speed 1.0°/min, sampling rate 0.02°/step, divergence slit 0.5°, scattering slit 0.5°, receiving slit 0.15 mm.

The electroconductivity is improved with an increase in the content of the carbon incorporated. However, with this increase, the content of olivine LiMnPO₄ as active material is decreased, and with this decrease, the density of electrode is decreased. Therefore, the energy density (Wh/kg) given by the electrode is unavoidably decreased. Accordingly, the content of the carbon incorporated is preferably 3 to 7 wt %.

On the basis of the above investigation results, the present invention is characterized by a positive electrode active material which is a composite material comprising carbon and a material having an olivine structure (space group: Pnma) and represented by Li_{1-y}[Mn₁₋ₓMₓ]PzO₄ (0<x≦0.3, −0.05≦y<1, 0.99≦z≦1.03, and M includes at least one of Li, Mg, Ti, Co, Ni, Zr, Nb, Mo and W) and is characterized in that the average half width in powder X-ray diffractometry is 0.17 or more and that the intensity ratio between diffraction lines, I (011)/I (131) in the powder X-ray diffractometry is not less than 0.7 and not more than 1.0; and a lithium secondary battery using the positive electrode active material and having a high thermal stability. In addition, conventional positive electrode active materials having an olivine structure are composed mainly of iron and hence do not permit control of iron powder which is a cause of the deterioration of the safety and reliability of batteries. On the other hand, the present invention is characterized by making it possible to control iron impurity by avoiding the employment of iron as a constituent element for design.

Next, a synthesis method is explained. In the case of central metals such as Co and Ni which are stable in a divalent oxidized state, namely, which are stable as divalent metals, it is relatively easy to synthesize the olivine phase of LiMPO₄ by mixing a compound of such a transition metal with a lithium compound and a phosphorus compound such as phosphorus pentaoxide, and sintering the resulting mixture in the air, followed by quenching. On the other hand, in the case of central metals such as iron and manganese which are stable in a trivalent oxidized state, namely, which are stable as trivalent metals, they should be allowed to react while preventing their oxidation into a trivalent state, by sintering under an inert atmosphere such as a nitrogen gas or argon gas stream or under a reductive atmosphere containing hydrogen. In this case, as mentioned above, the addition of carbon powder having a large specific surface area or a hydrocarbon removes the excess oxygen and produces carbon dioxide at the time of decomposition. Therefore, the atmosphere itself becomes a reductive atmosphere, so that the oxidation into a trivalent state can be further prevented.

A positive electrode is formed by the use of the positive electrode active material, for example, by any of the following methods: a method in which a mixture of powder of the above-mentioned compound and binder powder such as polytetrafluoroethylene is subjected to crimping molding on a support of stainless steel or the like; a method in which such mixture powder is mixed with electroconductive powder such as acetylene black or graphite in order to impart electroconductivity to the mixture powder, and binder powder such as polytetrafluoroethylene is added thereto if necessary, followed by placing the resulting mixture in a metal container, or the mixture obtained above is subjected to crimping molding on a support of stainless steel or the like; and a method in which a mixture of powder of the above-mentioned compound, a conductive aid and polyvinylidene fluoride is dispersed in a solvent such as an organic solvent to obtain a slurry, and the slurry is applied on a metal substrate. The kind and amount of the conductive aid added in the formation of the electrode should be limited because the positive electrode active material used in the present invention contains carbon already incorporated therewith in its synthesis. The carbon content of the positive electrode is preferably not less than 5 wt % and not more than 10 wt % for preventing the decrease of the energy density.

When a lithium metal is used as a negative electrode active material, it is formed into a negative electrode by processing into a sheet or pressure bonding of the sheet to an electric conductor net of copper, nickel, stainless steel or the like, as in the case of conventional lithium batteries. As the negative electrode active material, there can be used, besides lithium, lithium alloys, lithium compounds, heretofore well-known alkali metals and alkaline earth metals, such as sodium, potassium and magnesium, and materials which permit intercalation and deintercalation of alkali metal or alkaline earth metal ions, such as alloys of the metals mentioned above, and carbon materials. When of these materials, a flat graphite material having a low operating voltage is used, a battery having a high energy density can be constructed.

On the other hand, a battery having a high energy density can be constructed also by using an alloy negative electrode comprising silicon or tin as one of constituent elements. In addition, when the above-mentioned alloy negative electrode and an amorphous or slightly crystalline carbon material are used in a negative electrode, the voltage profile has a definite gradient, so that a battery can be constructed which permits relatively easy analysis of residual capacity.

As the electrolyte, there can be used lithium salts such as CF₃SO₃Li, C₄F₉SO₈Li, (CF₃SO₂)₂NLi, (CF₃SO₂)₃CLi, LiBF₄, LiPF₆, LiClO₄ and LiC₄O₈B. A solvent for dissolving such an electrolyte is preferably a nonaqueous solvent. Examples of the nonaqueous solvent include chain carbonates, cyclic carbonates, cyclic esters, nitrile compounds, acid anhydrides, amide compounds, phosphate compounds and amine compounds. Specific examples of the nonaqueous solvent include ethylene carbonate, diethyl carbonate (DEC), propylene carbonate, dimethoxyethane, γ-butylolactone, n-methylpyrrolidinone, N,N-dimethylacetamide, acetonitrile, mixtures of propylene carbonate and dimethoxyethane, and mixtures of sulfolane and tetrahydrofuran. An electrolyte layer inserted between the positive electrode and the negative electrode may be either a solution of the above-mentioned electrolyte in the nonaqueous solvent or a polymer gel containing this electrolyte solution (a polymer gel electrolyte).

In addition, various conventional materials can be used in other members such as structural materials including a separator and a battery case, and materials for the other members are not particularly limited. As the separator, a polyolefin porous film is generally used. Regarding a material for the separator, a composite film composed of a polyethylene and a polypropylene is used. Since the separator is required to have heat resistance, ceramics composite separators having ceramics (e.g. alumina) applied thereon, and ceramics composite separators obtained by using such ceramics as a part of a material constituting a porous film have been developed. The positive electrode material used in the present invention is characterized in that since it has an olivine structure, it has a low oxygen-supplying ability at a high temperature during charging, so that the heat of reaction with an electrolysis solution is low. Therefore, it can be expected that a lithium secondary battery having a higher thermal stability can be obtained by combining a positive electrode composed of the positive electrode active material used in the present invention with a ceramics composite separator having a high heat resistance.

Concrete investigation results are summarized below in Table 2, and the details are explained.

### EXAMPLE 1

### LiMnPO₄/C (Dextrin)

Zirconium oxide balls for milling were placed in a zirconium oxide pot, and 2.675 g of LiH₂PO₄ (mfd. by Aldrich Chemical Co.), 4.373 g of MnC₂O₄.2H₂O (mfd. by Pure Material Laboratory Ltd.) and 0.826 g of dextrin (mfd. by Wako Pure Chemical Industries Ltd.) were mixed for 30 minutes at a number of revolution of level 3 by the use of a planetary ball mill (mfd. by Fritsch). The resulting mixed powder was placed in an alumina crucible and first-sintered at 400° C. for 10 hours in an argon stream of 0.3 L/min. After the first-sintered powder was once pulverized in an agate mortar, it was placed in an alumina crucible and second-sintered at 700° C. for 10 hours in an argon stream of 0.3 L/min. The powder thus obtained was pulverized in an agate mortar and subjected to size control with a 45-μm mesh sieve to obtain the desired material.

Composition analysis was carried out by ICP method to find the followings: composition Li_{1.00}Mn_{0.98}P_{1.02}O₄, carbon content 6.1 wt %, Fe impurity content 60 ppm.

Whether the material obtained had the desired crystal structure or not was judged with the above-mentioned powder X-ray diffraction apparatus (Model RINT-2000, mfd. by Rigaku International Corporation). Crystals of the material belonged to orthorhombic system, and the lattice constants were obtained by method of least squares. (RIETAN-2000 was used as a program.) The following lattice constants were obtained: axis a length 10.391 Å, axis b length 6.072 Å, axis c length 4.725 Å. The intensity ratio between a (011) diffraction line near 20° and a (131) diffraction line near 35° was 0.73. In addition, the average half width was 0.173.

When the composition and the carbon content were evaluated, they were accurately determined by ICP analysis method. Regarding the electrode characteristics, the material obtained, acetylene black as conductive aid, and a binder solution (KF polymer #1120, mfd. by Kureha Chemical Industry Co., Ltd.) were measured so that their proportions would be 85 wt %, 5 wt % and 10 wt % (in terms of PVdF content), and the mixture thus obtained was adjusted to a given viscosity with n-methylpyrrolidone (NMP). The coating material thus obtained was applied on aluminum foil of 15 μm thickness with an applicator having a 200-μm gap. The resultant coating film was subjected to predrying of NMP at 80° C. for drying, and then dried at 120° C. under reduced pressure to obtain a positive electrode.

Regarding a model cell used for evaluating the electrode, the discharge use efficiency was measured at room temperature by the use of a bipolar cell using a lithium metal as a negative electrode. The positive electrode was formed into a circular shape of 15 mmφ, and a polyolefin porous separator of 30μ thickness was used. The lithium metal was used as the negative electrode. As an electrolysis solution, 1M LiPF₆ EC/MEC (⅓) solution was used. The capacity use efficiency was calculated from a discharge capacity attained by charging and discharging at a current density of 0.1 mA/cm² and a voltage of 3 V to 4.3 V, on the basis of a theoretical capacity 170.9 mAh/g (in the case where y=1) shown by the following formula. As a result, it was found to be 23%. In this case, the charge termination condition was a current value of 0.01 mA/cm².

LiMnPO₄→yLi⁺+Li_{1-y}MnPO₄+ye⁻ (reaction formula 2)

TABLE 1

| | | Carbon content | Carbon source | Fe content |
|---|---|---|---|---|
| | Composition | (wt %) | material | (ppm) |
| Example 1 | Li_{1.00}Mn_{0.98}P_{1.02}O₄ | 6.1 | Dextrin | 62 |
| Example 2 | Li_{1.01}Mn_{0.96}Ti_{0.03}P_{1.02}O₄ | 6.0 | Dextrin | 50 |
| Example 3 | Li_{1.01}Mn_{0.94}Ti_{0.05}P_{1.02}O₄ | 5.9 | Dextrin | 55 |
| Example 4 | Li_{1.02}Mn_{0.79}Co_{0.15}Ti_{0.05}P_{1.02}O₄ | 6.2 | Dextrin | 70 |
| Example 5 | Li_{1.00}Mn_{0.79}Ni_{0.14}Ti_{0.05}P_{1.02}O₄ | 6.1 | Dextrin | 75 |
| Example 6 | Li_{1.00}Mn_{0.94}Zr_{0.05}P_{1.02}O₄ | 6.0 | Dextrin | 42 |
| Comparative | Li_{1.00}Mn_{0.98}P_{1.02}O₄ | 5.5 | cellulose | 60 |
| Example 1 | | | | |
| Comparative | Li_{1.01}Mn_{0.98}P_{1.02}O₄ | 5.1 | Ketjen black | 73 |
| Example 2 | | | | |
| Comparative | Li_{1.01}Mn_{0.49}Co_{0.45}Ti_{0.05}P_{1.02}O₄ | 5.2 | Dextrin | 70 |
| Example 3 | | | | |

TABLE 2

| | | | | Average | | Capacity |
|---|---|---|---|---|---|---|
| | Axis a | Axis b | Axis c | half | I(011)/ | use |
| | length | length | length | width | I(131) | efficiency |
| | (Å) | (Å) | (Å) | (°) | ratio | (%) |
| Example 1 | 10.391 | 6.071 | 4.718 | 0.173 | 0.73 | 23 |
| Example 2 | 10.388 | 6.070 | 4.718 | 0.170 | 0.77 | 50 |
| Example 3 | 10.383 | 6.067 | 4.717 | 0.170 | 0.80 | 48 |
| Example 4 | 10.379 | 6.061 | 4.717 | 0.165 | 0.85 | 70 |
| Example 5 | 10.381 | 6.068 | 4.716 | 0.160 | 0.75 | 65 |
| Example 6 | 10.382 | 6.066 | 4.714 | 0.170 | 0.73 | 50 |
| Comparative | 10.390 | 6.070 | 4.718 | 0.133 | 0.65 | 0 |
| Example 1 | | | | | | |
| Comparative | 10.396 | 6.072 | 4.725 | 0.139 | 0.60 | 0 |
| Example 2 | | | | | | |
| Comparative | 10.305 | 6.023 | 4.710 | 0.170 | 0.95 | 20 |
| Example 3 | | | | | | |

### EXAMPLE 2

### LiMn_{0.96}Ti_{0.03}PO₄/C (Dextrin)

Synthesis and evaluation were carried out in the same manner as in Example 1 except for using as starting materials 2.684 g of LIH₂PO₄ (mfd. by Aldrich Chemical Co.), 4.295 g of MnC₂O₄.2H₂O (mfd. by Kanto Chemical Co., Ltd.), 0.213 g of titanium tetraisopropoxide (mfd. by Kanto Chemical Co., Ltd.) and 0.823 g of dextrin (mfd. by Kanto Chemical Co., Ltd.). The results obtained are summarized in Table 1 and Table 2. Here, the capacity used at a voltage of 4.3 V or lower was dependent on the manganese content. For comparison with real capacity, the capacity use efficiency was calculated by taking a capacity at an efficiency of 100% as 170.9 mAh/g, as in [Example 1].

### EXAMPLE 3

### LiMn_{0.95}Ti_{0.05}PO₄/C (Dextrin)

Synthesis and evaluation were carried out in the same manner as in Example 1 except for using as starting materials 2.680 g of LIH₂PO₄ (mfd. by Aldrich Chemical Co.), 4.252 g of MnC₂O₄.2H₂O (mfd. by Kanto Chemical Co., Ltd.), 0.350 g of titanium tetraisopropoxide (mfd. by Kanto Chemical Co., Ltd.) and 0.826 g of dextrin (mfd. by Kanto Chemical Co., Ltd.). The results obtained are summarized in Table 1 and Table 2.

### EXAMPLE 4

### LiMn_{0.80}Co_{0.15}Ti_{0.05}PO₄/C (Dextrin)

In 200 ml of ion-exchanged water were dissolved MnSO₄.5H₂O and CoSO₄.7H₂O to concentrations of 0.85 M and 0.15 M, respectively. In addition, 1.13 g of NH₂NH₂H₂O was added as a reducing agent and 0.86 g of (NH₄) SO₄ was added as a complexing agent. To the solution thus obtained was added NaOH aqueous solution obtained by dissolving 12 g of NaOH in 150 ml of ion-exchanged water, with stirring at room temperature at a dropping rate of 4 ml/min to obtain a precipitate. In this case, nitrogen was bubbled through both solutions. Under an inert atmosphere, the precipitate obtained was washed with ion-exchanged water and filtered. As the ion-exchanged water, that subjected to bubbling treatment with nitrogen was used in all the cases. The sample thus obtained was dried at 90° C. for 12 hours under an inert atmosphere to obtain a precursor. With 2.310 g of the precursor obtained by the above method were mixed 2.684 g of LiH₂PO₄ and 0.355 g of titanium tetraisopropoxide by the same method as in [Example 1]. Therewith was mixed 0.826 g of dextrin and the resulting mixture was sintered at 700° C. for 12 hours under an Ar/H₂ (containing 2% H₂) atmosphere to obtain the desired material. The results for this material are summarized in Table 1 and Table 2.

### EXAMPLE 5

### LiMn_{0.80}Ni_{0.15}Ti_{0.05}PO₄/C (Dextrin)

An objective precursor was obtained in the same manner as in [Example 4] except for using NiSO₄.6H₂O in place of CoSO₄.7H₂O. A given amount of the precursor obtained above, 2.675 g of LiH₂PO₄ and 0.351 g of titanium tetraisopropoxide were mixed, and 0.826 g of dextrin was mixed therewith. Synthesis and evaluation were carried out in the same manner as in [Example 1]. The results obtained were summarized in Table 1 and Table 2.

### EXAMPLE 6

### LiMn_{0.95}Zr_{0.05}PO₄/C (Dextrin)

Synthesis and evaluation were carried out in the same manner as in Example 1 except for using as starting materials 2.675 g of LIH₂PO₄ (mfd. by Aldrich Chemical Co.), 4.250 g of MnC₂O₄.2H₂O (mfd. by Kanto Chemical Co., Ltd.), 0.154 g of ZrO₂ (mfd. by Kanto Chemical Co., Ltd.) and 0.825 g of dextrin (mfd. by Kanto Chemical Co., Ltd.). The results obtained are summarized in Table 1 and Table 2.

### COMPARATIVE EXAMPLE 1

### LiMnPO₄/C (Cellulose)

Synthesis and evaluation were carried out in the same manner as in Example 1 except for using as starting materials 2.675 g of LIH₂PO₄ (mfd. by Aldrich Chemical Co.), 4.373 g of MnC₂O₄.2H₂O (mfd. by Kanto Chemical Co., Ltd.) and 0.827 g of cellulose (mfd. by Wako Pure Chemical Industries, Ltd.). The results obtained are summarized in Table 1 and Table 2.

### COMPARATIVE EXAMPLE 2

### LiMnPO₄/C (KB)

Synthesis and evaluation were carried out in the same manner as in Example 1 except for using as starting materials 2.676 g of LIH₂PO₄ (mfd. by Aldrich Chemical Co.), 4.375 g of MnC₂O₄.2H₂O (mfd. by Kanto Chemical Co., Ltd.) and 0.221 g of ketjen black (mfd. by Lion Corporation). The results obtained are summarized in Table 1 and Table 2.

### COMPARATIVE EXAMPLE 3

### LiMn_{0.50}Co_{0.45}Ti_{0.05}PO₄/C (Dextrin)

In 200 ml of ion-exchanged water were dissolved MnSO₄.5H₂O and CoSO₄.7H₂O to concentrations of 0.53 M and 0.47 M, respectively, and a precursor was synthesized by the same method as in [Example 4]. With 2.350 g of the precursor were mixed 2.684 g of LiH₂PO₄ and 0.350 g of titanium tetraisopropoxide, and 0.830 g of dextrin was mixed therewith. Synthesis and evaluation were carried out in the same manner as in [Example 1]. The results obtained are summarized in Table 1 and Table 2.

Table 1 summarizes the composition and carbon content (wt %) of each positive electrode active material, a material for its carbon source, and its Fe content (ppm). As a result, the followings could be confirmed: the carbon content of all the samples examined in the present invention is not less than 3 wt % and not more than 7 wt %, their iron content is less than 100 ppm because no iron is used as a constituent element, and iron can be controlled as an impurity.

Table 2 summarizes the result of the powder X-ray diffraction and the result of the electrode evaluation. From the result of the powder X-ray diffraction, it was found that while a small amount of an impurity phase was present, all the main diffraction lines could be assigned to the desired olivine structure. As a result of calculating the lattice constants, it was found that the lattice constants were not markedly changed when M represented Ti and Zr and the degree of replacement with M was 0.05 or less, and that the axis lengths were little changed as follows: the axis a length changed from 10.38 Å to 10.39 Å, the axis b length was 6.07 Å and the axis c length changed from 4.72 Å to 4.73 Å. When the degree of replacement is more than 0.05, an impurity phase was markedly found as a result of the powder X-ray diffraction. Therefore, it was found that the degree of replacement is preferably 0.05 or less. The followings were also found. When M includes Co, all of the axis a length, the axis b length and the axis c length tend to be decreased. On the other hand, when M includes Ni, they tend to be somewhat increased.

As a result of detailed investigation of the dependence of half width, a measure of the size of crystallites, the followings were found. When the samples of Example 1 and Comparative Examples 1 and 2 were compared which had substantially the same compositions, the sample of Example 1 obtained by using dextrin as a carbon source material had an average half width value of 0.173, and the sample of Comparative Example 1 obtained by using cellulose, a similar polysaccharide of glucose had an average half width value of 0.133. This value was lower than 0.139, the average half width value of the sample of Comparative Example 2 obtained by using ketjen black. Here, the half width and the size of crystallites are calculated by Scherrer's equation (3) as described in, for example, the literature Seiki Katoh, “X-ray Diffractometry”, Uchida Rokakuho Co. (1998).

Dₕₖₗ=Kλ/β cos θ Equation (3)

wherein Dₕₖₗ is the size of crystallites in a direction perpendicular to (hkl) planes; K is a constant; λ is the wavelength of X-ray, β is the half width of diffraction line, and θ is angle of diffraction.

From the above fact, it was found that since the size of crystallites is decreased with an increase in the half width, the sample of Example 1 obtained by using dextrin is a material having a smaller crystallite size, as compared with the sample of Comparative Example 1 obtained by using cellulose and the sample of Comparative Example 2 obtained by using ketjen black. It was confirmed that since dextrin is a polysaccharide of alpha-glucose and tends to have a steric structure when carbonized, it has a larger inhibitory effect on crystal growth as expected, than does cellulose, a polysaccharide of beta-glucose, when it is present among LiMnPO₄ particles. Therefore, dextrin, a polysaccharide of alpha-glucose is the most suitable as a material for suppressing the crystallite growth of LiMnPO₄ particles and assuring electroconductivity by carbon coating. As can be seen from the half width values of the samples of Examples 2 to 6, the samples having a half width value of 0.16 to 0.18 could be obtained by using dextrin as a carbon source material.

Next, the same tendency as in the case of the above-mentioned half width was observed in the value of I (011)/I (131), i.e., the intensity ratio between a diffraction line near 20°, a diffraction line represented by Miller indices (011) when assigned to orthorhombic system, and a diffraction line near 35°, a diffraction line similarly represented by Miller indices (131). When the samples of Example 1 and Comparative Examples 1 and 2 are compared which had substantially the same compositions, it can be seen that the sample of Example 1 has a larger intensity ratio value. The intensity ratio is an indication found by the present inventors in the process of the invention. It was found that the intensity ratio indicates the degree of blockage of a lithium transport pathway, and that because of the characteristics of olivine structure, the intensity ratio tends to be decreased when another metal element, Mn in this case, is present in a lithium site. Since olivine structure is naturally one-dimensional lithium transport pathway, the movement speed of lithium ions therein is slow. It was conjectured that when Mn is present in the olivine structure so as to block the pathway, the movement of lithium ions is greatly limited. That is, it was conjectured that for the function of olivine LiMnPO4 as a positive electrode material, it is more preferable to obtain fine particles by reduction of the size of crystallites as in the case of LiFePO₄, and increase the value of I (011)/I (131). The samples of Comparative Examples 1 and 2 are materials having substantially the same compositions and lattice constants as those of the sample of Example 1 but have smaller half width values and I (011)/I (131) ratio values of 0.65 and 0.60, respectively, which are smaller than the value 0.73 of the sample of Example 1. The capacity use efficiency is 23% for the sample of Example 1 and is 0% for the samples of Comparative Examples 1 and 2. Therefore, the value of I (011)/I (131) was considered an important factor which influences the exhibition of the electrode function of an olivine LiMnPO₄ material.

For more detailed research, the correlation between the value of I (011)/I (131) and the capacity use efficiency (%) was investigated by plotting the value as abscissa and the efficiency as ordinate. As a result, it was found that the capacity use efficiency is improved when the value of I (011)/I (131) is not less than 0.7 and not more than 1.0. In the case of LiMnPO₄ composition, the value is not less than 0.7 and not more than 0.8. The present inventors found that when Mn is replaced with a foreign metal atom(s) (M) (Li[Mn₁₋ₓMₓ]PO₄ wherein M includes at least one of Co, Ni, Ti, Zr, Nb, Mo and W), the value of I (011)/I (131) is increased as in Examples 2 to 6 and Comparative Example 3, and is not less than 0.7 and not more than 1.0, and that the value is further increased particularly when Mn is replaced with Co. Particularly when the value of I (011)/I (131) is not less than 0.8 and not more than 0.9, a sample having a capacity use efficiency of 40% or more could be obtained as in Example 4.

On the other hand, when charge termination voltage is 4.3 V, the charge and discharge capacity decreases with the replacement with Co or Ni because the redox potential of Co²⁺ or Ni²⁺ relative to Li metal is more than 4.3 V. That is, since the charge capacity decreases with an increase of the x value in Li[Mn₁₋ₓCoₓ]PO₄, the discharge capacity itself does not increase in spite of the improvement of the charge and discharge efficiency and tends to be substantially the same or decrease. It was considered that the x value was preferably 0.3 or less because the capacity use efficiency in the case where x=0.5, i.e., the case of Comparative Example 3, was lower than that in the case where x=0.2, i.e., the case of Example 4.

It should be further understood by those skilled in the art that although the foregoing description has been made on embodiments of the invention, the invention is not limited thereto and various changes and modifications may be made without departing from the spirit of the invention and the scope of the appended claims.

### ADVANTAGES OF THE INVENTION

The present invention makes it possible to provide at low cost a nonaqueous electrolyte battery having a battery voltage of about 4 V and an excellent safety, by the use of a positive electrode active material of olivine lithium phosphate composed mainly of manganese and not containing iron as a constituent element.

1. A nonaqueous electrolyte secondary battery comprising: a positive electrode being capable of undergoing lithium ion intercalation and deintercalation; and a negative electrode being capable of undergoing lithium ion intercalation and deintercalation, which are formed with an electrolyte inserted between them,
wherein the positive electrode comprises a positive electrode active material,
the positive electrode active material is a composite material comprising a material represented by Li_{1-y}Mn_{1-α}PzO₄ (−0.05<α<0.05, −0.05≦y<1, 0.99≦z≦1.03) and a carbon material, and
the ratio of the intensity of a (011) diffraction line near 20° to the intensity of a (131) diffraction line near 35° in powder X-ray diffractometry of the composite material is not less than 0.7 and not more than 0.8.

2. The nonaqueous electrolyte secondary battery according to claim 1, wherein an average half width in the powder X-ray diffractometry of the composite material is not less than 0.16 and not more than 0.18.

3. The nonaqueous electrolyte secondary battery according to claim 1, wherein a carbon content of the composite material is not less than 3 wt % and not more than 7 wt %.

4. The nonaqueous electrolyte secondary battery according to claim 1, wherein the carbon material is a polysaccharide comprising alpha-glucose.

5. The nonaqueous electrolyte secondary battery according to claim 1, wherein the carbon material is dextrin.

6. A nonaqueous electrolyte secondary battery comprising: a positive electrode being capable of undergoing lithium ion intercalation and deintercalation; and a negative electrode being capable of undergoing lithium ion intercalation and deintercalation, which are formed with an electrolyte inserted between them,
wherein the positive electrode comprise: a positive electrode combination agent comprising a positive electrode active material and a conductive aid; and a positive electrode current collector,
the positive electrode active material is a composite material comprising a material represented by Li_{1-y}Mn_{1-α}PzO₄ (−0.05<α<0.05, −0.05≦y<1, 0.99≦z≦1.03) and a carbon material,
an average half width in powder X-ray diffractometry of the composite material is not less than 0.16 and not more than 0.18,
the ratio of the intensity of a (011) diffraction line near 20° to the intensity of a (131) diffraction line near 35° in the powder X-ray diffractometry of the composite material is not less than 0.7 and not more than 0.8,
the conductive aid is a carbon material, and
a carbon content of the positive electrode combination agent is not less than 5 wt % and not more than 10 wt %.

7. A nonaqueous electrolyte secondary battery comprising: a positive electrode being capable of undergoing lithium ion intercalation and deintercalation; and a negative electrode being capable of undergoing lithium ion intercalation and deintercalation, which are formed with an electrolyte inserted between them,
wherein the positive electrode comprises a positive electrode active material,
the positive electrode active material is a composite material comprising a material represented by Li_{1-y}[Mn₁₋ₓMₓ]PzO₄ (0<x≦0.3, −0.05≦y<1, 0.99≦z≦1.03, and M includes at least one of Li, Mg, Ti, Co, Ni, Zr, Nb, Mo or W) and a carbon material,
an average half width in powder X-ray diffractometry of the composite material is not less than 0.16 and not more than 0.18, and
the ratio of the intensity of a (011) diffraction line near 20° to the intensity of a (131) diffraction line near 35° in the powder X-ray diffractometry of the composite material is not less than 0.7 and not more than 1.0.

8. The nonaqueous electrolyte secondary battery according to claim 7, wherein the positive electrode active material is a composite material comprising a material represented by Li_{1-y}[Mn₁₋ₓ₁₋ₓ₂M1ₓ₁M2ₓ₂]PzO₄ (0<x1+x2≦0.3, 0<x1≦0.25, 0<x2≦0.05, −0.05≦y<1, 0.99≦z≦1.03; M1 includes at least one of Co or Ni, and M2 includes at least one of Mg, Ti, Zr, Nb, Mo or W) and a carbon material.

9. The nonaqueous electrolyte secondary battery according to claim 7, wherein a carbon content of the positive electrode active material is not less than 3 wt % and not more than 7 wt %.

10. The nonaqueous electrolyte secondary battery according to claim 7, wherein a Fe content of the positive electrode active material is 100 ppm or less.
